(19) United States
(12) Patent Application Publication
(10) Pub. No.: US 2017/0361838 A1
(43) Pub. Date: Dec. 21, 2017

(54) AUTONOMOUS EMERGENCY BRAKING WITH MECHANICAL TRANSMISSION

(71) Applicant: BorgWarner Inc., Auburn Hills, MI (US)

(72) Inventors: Joel M. MAGUIRE, Hartland, MI (US); Mark Ray BUCHANAN, Rochester Hills, MI (US); Paul NAHRA, Shelby Township, MI (US)

(21) Appl. No.: 15/623,454

(22) Filed: Jun. 15, 2017

Related U.S. Application Data
(60) Provisional application No. 62/351,623, filed on Jun. 17, 2016.

(51) Int. Cl. B60W 30/08; G08G 1/16; B60W 10/02; B60W 10/184; F16D 48/06

(52) U.S. Cl. CPC B60W 30/08; B60W 10/184; F16D 48/066; B60W 10/02; G08G 1/16; B60W 2710/021; B60W 2550/10; B60W 2420/52; B60W 2710/18; B60Y 2400/164; F16D 2500/10412; F16D 2500/3128; B60Y 2400/14

(57) ABSTRACT

A number of variations may include an autonomous emergency braking system including a device for automatically opening a clutch of a transmission without driver action required. A number of variations may include a method comprising providing an autonomous emergency braking system including a device for automatically opening a clutch of a transmission without driver action required, using a sensor to detect a potential collision, and activating the device when a collision is detected to open a clutch of a transmission without driver action or input.

### CROSS-REFERENCE TO RELATED APPLICATIONS

This application claims the benefit of U.S. Application Ser. No. 62/351,623 filed Jun. 17, 2016.

### TECHNICAL FIELD

The field to which the disclosure generally relates to includes autonomous emergency braking.

### SUMMARY OF ILLUSTRATIVE VARIATIONS

A number of variations may include an autonomous emergency braking system including a device for automatically opening a clutch of a transmission without driver action required.

A number of variations may include a method comprising providing an autonomous emergency braking system including a device for automatically opening a clutch of a transmission without driver action required, using a sensor to detect a potential collision, and activating the device when a collision is detected to automatically open a clutch of a transmission without driver action or input.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a system according to a number of variations; and

FIG. 2 illustrates a system according to a number of variations; and

FIG. 3 illustrates a system according to a number of variations.

### DETAILED DESCRIPTION OF ILLUSTRATIVE VARIATIONS

The following description of the variations is merely illustrative in nature and is in no way intended to limit the scope of the invention, its application, or uses.

A number of variations may include an autonomous emergency braking system including a device for automatically opening a clutch of a transmission without drive action required. Opening the clutch or clutches allows the engine to be decoupled from the driveline, effectively removing a significant rotational inertia/mass from the vehicle, enabling shorter stopping distances, while still allowing the engine to spin and provide safety critical power features which may include vacuum, electrical, and hydraulic systems.

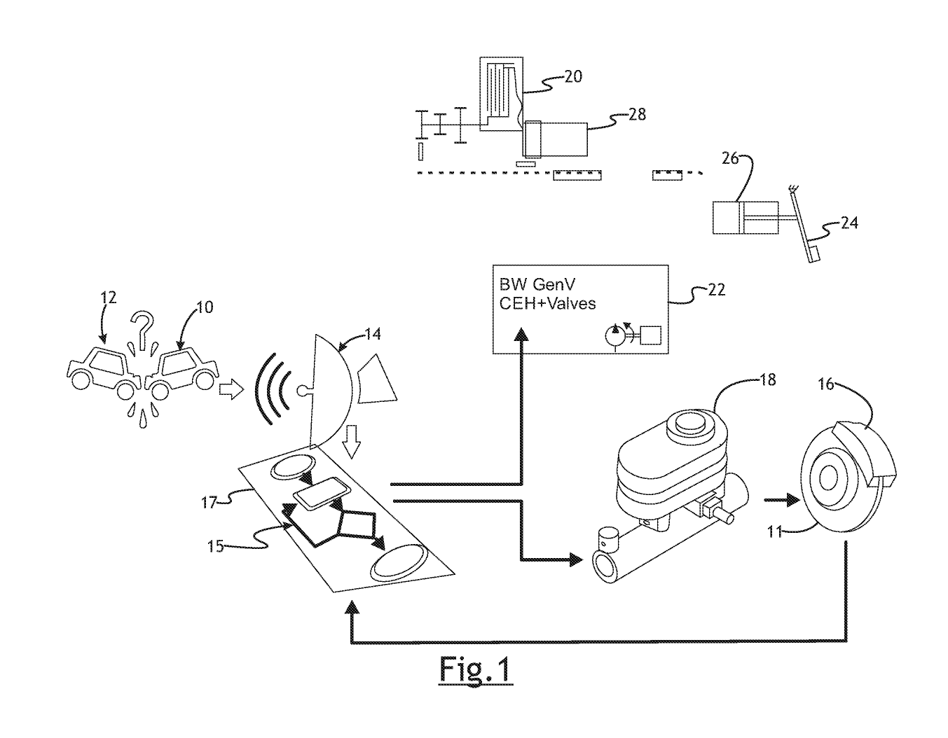

Referring to FIG. 1, in a number of variations a vehicle 10 may include sensing technology 14, such as radar sensors, vision sensors, and the like, as well as a controller 17, such as a computer of an electronic control module, which may include software including an autonomous braking algorithm or method to cause a vehicle to aggressively brake in the event of a determined pending collision with another vehicle or object 12 by activating an automatic actuator 18 to apply brakes 16 to a disk or drum 11 connected to a wheel of the vehicle 10. In a number of variations a hydraulic device or module 22 may be provided including an e-motor, pump, hydraulics and control mechanism, such as an algorithm and computing device, to supply hydraulic fluid to the clutch 20 to open the same. In a number of variations the system may include a clutch pedal 24 connected to a master cylinder 26 and a slave cylinder 28 connected to the clutch 20. In a number of variations the hydraulic device or module 22 may be interposed between the master cylinder 26 and the slave cylinder 28. When a pending collision is detected the controller 17 may signal or cause the hydraulic device or module 22 to activate to provide hydraulic fluid to the clutch 20 of a transmission to rapidly open the same without action or input from the driver of the vehicle 10.

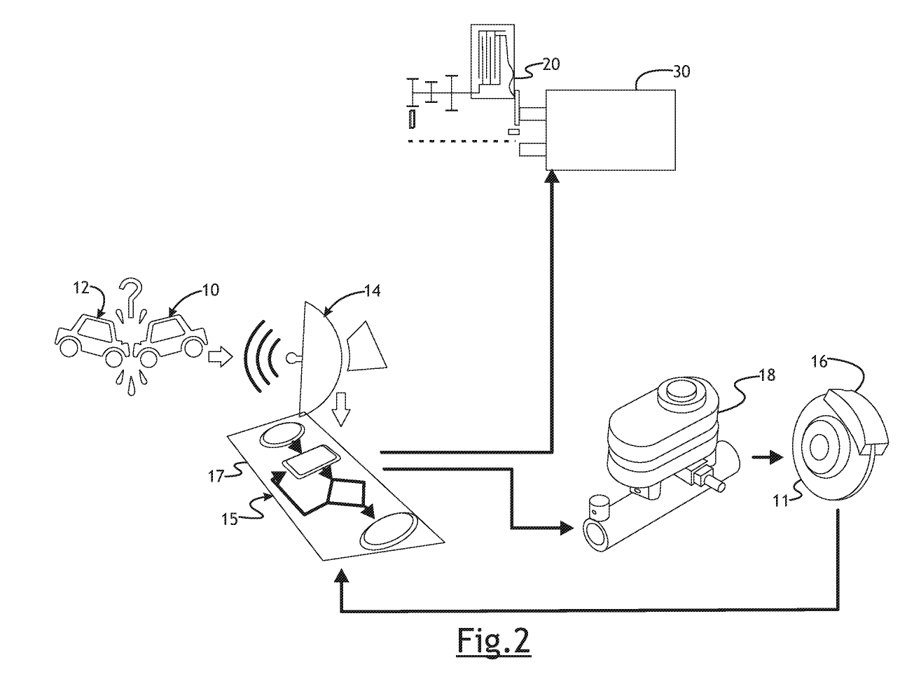

Referring to FIG. 2, in a number of variations an electric device 30 may be provided and may include a motor operatively connected to the clutch 20. When a pending collision is detected the controller 17 may signal or cause the hydraulic device or module 22 to activate to move the clutch plate away from each other to rapidly open the clutch 20 without action or input from the driver of the vehicle 10.

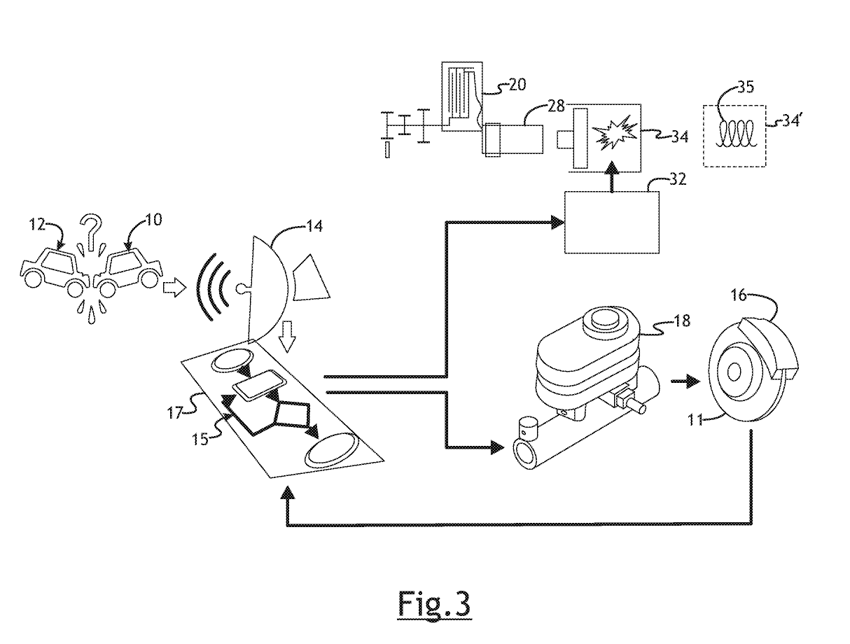

Referring to FIG. 3, a number of variations may include a stored energy device 34, 34′ that may be activated to rapidly open the clutch 20 without action or input from the driver of the vehicle 10. In a number of variations, the stored energy device 34′ may be a preloaded spring 35 or accumulator that may be automatically released to open the clutch 20 directly or to cause hydraulic fluid to rapidly open the clutch without action or input from the driver of the vehicle 10. In a number of variations, the stored energy device 34 may include a pyrotechnic device, the activation of which may open the clutch directly or to cause hydraulic fluid to rapidly open the clutch 20 without action or input from the driver of the vehicle 10.

A number of variations may include a device that is capable of automatically controlling the clutch in a transmission without driver action or input.

According to a first variation, a product may comprise an autonomous emergency braking system comprising a device for automatically opening a clutch of a transmission without driver action or input.

A second variation may include a product as set forth in the first variation wherein the system may comprise an e-motor and pump connected to a hydraulic system constructed and arranged to pump hydraulic fluid into the clutch to open the clutch.

A third variation may include a product as set forth in the first and second variations wherein the system comprises an electric device constructed and arranged to open the clutch directly.

A fourth variation may include a product as set forth in the first through third variation further comprising a stored energy device constructed and arranged to open the clutch directly or indirectly.

A fifth variation may include a product as set forth in the fourth variation wherein the stored energy device comprises a spring.

A sixth variation may include a product as set forth in the fourth variation wherein the stored energy device comprises an accumulator.

A seventh variation may include a product as set forth in the fourth variation wherein the stored energy device comprises a pyrotechnic device.

An eighth variation may include a product that may include a vehicle comprising an autonomous emergency braking system comprising at least one sensor and a device for automatically opening a clutch of a transmission without drive action or input.

A ninth variation may include a method that may include providing a vehicle comprising an autonomous emergency braking system comprising at least one brake and at least one sensor and a device for automatically activating a clutch of a transmission; sensing an impending collision via the at least one sensor; and activating the device for automatically activating a clutch of a transmission comprising opening the clutch of a transmission.

A tenth variation may include a method as set forth in the ninth variation wherein activating the autonomous emergency braking system further comprises activating the at least one brake.

An eleventh variation may include a method as set forth in the ninth or tenth variations wherein the autonomous emergency braking system comprises an e-motor and pump connected to a hydraulic system constructed and arranged to pump hydraulic fluid into the clutch to open the clutch.

A twelfth variation may include a method as set forth in the ninth through eleventh variations wherein the autonomous emergency braking system comprises an electric device constructed and arranged to open the clutch.

A thirteenth variation may include a method as set forth in the ninth through twelfth variations wherein the autonomous emergency braking system comprises a stored energy device constructed and arranged to open the clutch directly or indirectly.

A fourteenth variation may include a method as set forth in the thirteenth variation wherein the stored energy device comprises a spring.

A fifteenth variation may include a method as set forth in the thirteenth variation wherein the stored energy device comprises an accumulator.

A sixteenth variation may include a method as set forth in the thirteenth variation wherein the stored energy device comprises a pyrotechnic device.

A seventeenth variation may include a method that may include a vehicle comprising an autonomous emergency braking system comprising a device for automatically opening a clutch of a transmission; at least one sensor constructed and arranged to detect impending collisions with the vehicle; and a motor and pump connected to a hydraulic system constructed and arranged to pump hydraulic fluid into the clutch to open the clutch when the at least one sensor detects an impending collision.

The above description of select variations within the scope of the invention is merely illustrative in nature and, thus, variations or variants thereof are not to be regarded as a departure from the spirit and scope of the invention.

What is claimed is:

1. A product comprising:
an autonomous emergency braking system comprising a device for automatically opening a clutch of a transmission without driver action or input.

2. A product as set forth in claim 1 wherein the system comprises an e-motor and pump connected to a hydraulic system constructed and arranged to pump hydraulic fluid into the clutch to open the clutch.

3. A product as set forth in claim 1 wherein the system comprises an electric device constructed and arranged to open the clutch directly.

4. A product as set forth in claim 1 further comprising a stored energy device constructed and arranged to open the clutch directly or indirectly.

5. A product as set forth in claim 4 wherein the stored energy device comprises a spring.

6. A product as set forth in claim 4 wherein the stored energy device comprises an accumulator.

7. A product as set forth in claim 4 wherein the stored energy device comprises a pyrotechnic device.

8. A product comprising:
a vehicle comprising an autonomous emergency braking system comprising at least one sensor and a device for automatically opening a clutch of a transmission without drive action or input.

9. A method comprising:
providing a vehicle comprising an autonomous emergency braking system comprising at least one brake and at least one sensor and a device for automatically activating a clutch of a transmission;
sensing an impending collision via the at least one sensor; and
activating the device for automatically activating a clutch of a transmission comprising opening the clutch of a transmission.

10. The method of claim 9 wherein activating the autonomous emergency braking system further comprises activating the at least one brake.

11. The method of claim 9 wherein the autonomous emergency braking system comprises an e-motor and pump connected to a hydraulic system constructed and arranged to pump hydraulic fluid into the clutch to open the clutch.

12. The method of claim 9 wherein the autonomous emergency braking system comprises an electric device constructed and arranged to open the clutch.

13. The method of claim 9 wherein the autonomous emergency braking system comprises a stored energy device constructed and arranged to open the clutch directly or indirectly.

14. The method of claim 13 wherein the stored energy device comprises a spring.

15. The method of claim 13 wherein the stored energy device comprises an accumulator.

16. The method of claim 13 wherein the stored energy device comprises a pyrotechnic device.

17. A product comprising:
a vehicle comprising an autonomous emergency braking system comprising a device for automatically opening a clutch of a transmission;
at least one sensor constructed and arranged to detect impending collisions with the vehicle; and
a motor and pump connected to a hydraulic system constructed and arranged to pump hydraulic fluid into the clutch to open the clutch when the at least one sensor detects an impending collision.
